(19) United States
(12) Patent Application Publication
(10) Pub. No.: US 2026/0253161 A1
(43) Pub. Date: Aug. 27, 2026

(54) VISUAL QUALITY OPTIMIZATION FOR GPU COMPOSITION

(71) Applicant: QUALCOMM Incorporated, San Diego, CA (US)

(72) Inventors: Yongjun XU, Beijing (CN); Xinchao YANG, Shanghai (CN); Nan ZHANG, Beijing (CN)

(21) Appl. No.: 18/992,963

(22) PCT Filed: Aug. 30, 2022
(86) PCT No.: PCT/CN2022/115718

§ 371 Date: Jan. 9, 2025

(51) Int. Cl. G06T 1/20; G06T 13/00

(52) U.S. Cl. CPC G06T 1/20; G06T 13/00

(57) ABSTRACT

Aspects presented herein relate to methods and devices for display processing including an apparatus, e.g., a CPU. The apparatus may obtain an indication of at least one frame including a plurality of layers, where the at least one frame is associated with display processing. The apparatus may map each of the plurality of layers for processing at a DPU or a GPU. Further, the apparatus may detect whether each of the plurality of layers is a rotation animation layer or a non-rotation animation layer based on the mapping. The apparatus may also divide a frame buffer into a set of ROIs for each non-rotation animation layer. The apparatus may also assign a first per-layer processor at the DPU to each rotation animation layer or at least one second per-layer processor at the DPU to each of the set of ROIs in the frame buffer for each non-rotation animation layer.

### TECHNICAL FIELD

The present disclosure relates generally to processing systems and, more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a central processing unit (CPU), a display processing unit (DPU), a graphics processing unit (GPU), or any apparatus that may perform display processing. The apparatus may obtain an indication of at least one frame including a plurality of layers, where the at least one frame is associated with the display processing. The apparatus may also map each of the plurality of layers for processing at a display processing unit (DPU) or a graphics processing unit (GPU). Additionally, the apparatus may mark, based on mapping each of the plurality of layers for the processing at the DPU or the GPU, each of the plurality of layers that are mapped for the processing at the DPU. The apparatus may also detect whether each of the plurality of layers is a rotation animation layer or a non-rotation animation layer based on the mapping for each of the plurality of layers. Moreover, the apparatus may divide a frame buffer into a set of regions of interest (ROIs) for each non-rotation animation layer in the plurality of layer. The apparatus may also assign a first per-layer processor at the DPU to each rotation animation layer in the plurality of layers or at least one second per-layer processor at the DPU to each of the set of ROIs in the frame buffer for each non-rotation animation layer in the plurality of layers. The apparatus may also transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers. Further, the apparatus may process each non-rotation animation layer in the plurality of layers based on the second composition stage for each of the set of ROIs in the frame buffer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example mask layer for display processing.

FIG. 5 is a diagram illustrating an example layer composition scheme for display processing.

FIG. 6 is a diagram illustrating an example of layer processing for DPU composition and GPU composition.

FIG. 7 is a diagram illustrating an example of a composition scheme for display processing.

FIG. 8 is a diagram illustrating example of a composition scheme for display processing.

FIG. 9 is a diagram illustrating an example of a flowchart for display layer processing associated with DPU composition and GPU composition.

FIG. 10 is a communication flow diagram illustrating example communications between a DPU, a GPU, and a display.

FIG. 11 is a flowchart of an example method of display processing.

FIG. 12 is a flowchart of an example method of display processing.

### DETAILED DESCRIPTION

Some types of display processing devices may utilize complex multiple content layouts in a single display processing layer or multiple display processing layers. That is, for graphics or display stacks in operating systems of the devices, there may be a single display processing layer (i.e., display layer or layer that is associated with display processing) or multiple display processing layers. For instance, there may be at least one display layer that may be associated with a screen or frame for a display processing device, such that the display panel at the device may be divided amongst the display layers. Additionally, for content or end users, there may be multiple content entities in the display processing layer. This may be due to operating system limitations and/or application rendering/resource management limitations. Further, some types of applications may choose to render in using a single display processing layer. Color processing capability on a per-region basis (i.e., for each region of interest (ROI) in a layer) may be utilized with certain types of display processing unit (DPU) architecture. Different types of DPU image processing (e.g., DPU per-layer flexible image processing) are utilized by current mobile consumer electronics devices. Based on the content of different layers, providing accurate per-layer image processing may be important to the perception of an end user. There may be a number of different types of per-layer image processing, such as video high dynamic range (HDR) layer tone mapping and processing and/or video standard dynamic range (SDR) layer visual contrast boosting. Types of per-layer image processing may also include proper tone mapping for photo image layers, game layer color processing and flexible visual control options provided to end users, flexible visual control options for video layers provided to end users, and flexible visual control options for texts/user interface (UI) layers provided to end users. In some aspects of display processing, there may be a visual difference between DPU composition and GPU composition. For example, this visual difference may lead to display screen flickering or refresh problems, such as a jank (e.g., the result of the display application not being able to keep up with the refresh rate of the display). Further, the visual difference between DPU composition and GPU composition may result in visual artifacts in different types of scenarios. In some instances, DPU per-layer image processing may make this problem worse. For instance, DPU per-layer image processing visual effects may be reduced or eliminated after display layers switch or revert to GPU composition. With the advent of flexible DPU per-layer image processing usage in different scenarios, the problem of visual effects reduction or elimination associated with GPU composition may be an important issue. There may be a number of issues with per-layer image processing for both DPU composition and GPU composition. This problem may be challenging in both technique bottleneck and engineering efforts at display devices. One of the reasons for these issues is DPU per-layer processing pipelines may be complex and flexible. Implementing the same processing techniques in a GPU pipeline compared to a DPU pipeline may be difficult. Aligning GPU path processing with DPU path processing for per-layer image processing may need increased engineering efforts. Also, GPU processing may utilize an increased amount of power consumption and may lead to potential performance degradation. The ability to optimize power and/or performance at a GPU in different scenarios may be a challenge. For instance, high definition video tone mapping and processing in GPUs may need increased engineering efforts, as there are a lot of limitations in power, performance, and/or visual quality. Aspects of the present disclosure may align GPU per-layer processing with DPU per-layer processing. That is, aspects presented herein may provide for similar visual effects or image boosting for per-layer processing for GPU composition compared to per-layer processing for DPU composition. For instance, aspects of the present disclosure may implement the same processing techniques in a GPU pipeline compared to a DPU pipeline. Additionally, aspects of the present disclosure may align GPU path processing with DPU path processing for per-layer image processing. Further, aspects of the present disclosure may optimize power and/or performance for per-layer image processing at a GPU compared to per-layer image processing at a DPU. For example, aspects presented herein may provide high definition or HDR video tone mapping and processing for both GPUs and DPUs.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

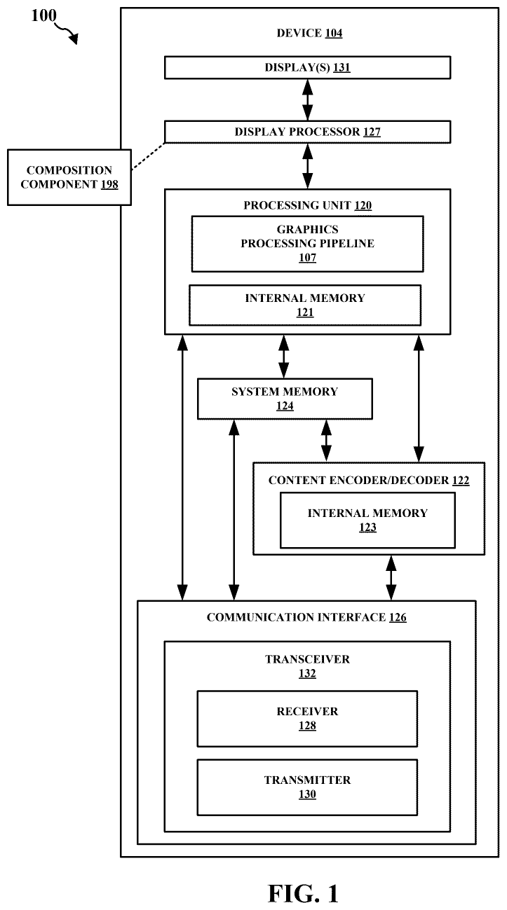

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a composition component 198 configured to obtain an indication of at least one frame including a plurality of layers, where the at least one frame is associated with the display processing. The composition component 198 may also be configured to map each of the plurality of layers for processing at a display processing unit (DPU) or a graphics processing unit (GPU). The composition component 198 may also be configured to mark, based on mapping each of the plurality of layers for the processing at the DPU or the GPU, each of the plurality of layers that are mapped for the processing at the DPU. The composition component 198 may also be configured to detect whether each of the plurality of layers is a rotation animation layer or a non-rotation animation layer based on the mapping for each of the plurality of layers. The composition component 198 may also be configured to divide a frame buffer into a set of regions of interest (ROIs) for each non-rotation animation layer in the plurality of layer. The composition component 198 may also be configured to assign a first per-layer processor at the DPU to each rotation animation layer in the plurality of layers or at least one second per-layer processor at the DPU to each of the set of ROIs in the frame buffer for each non-rotation animation layer in the plurality of layers. The composition component 198 may also be configured to transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers. The composition component 198 may also be configured to process each non-rotation animation layer in the plurality of layers based on the second composition stage for each of the set of ROIs in the frame buffer. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

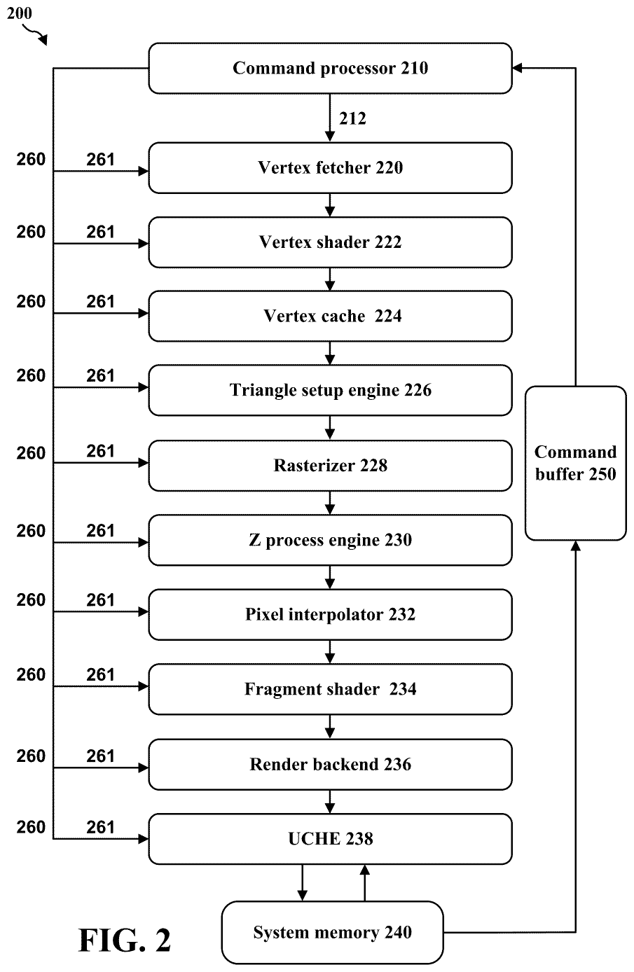

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

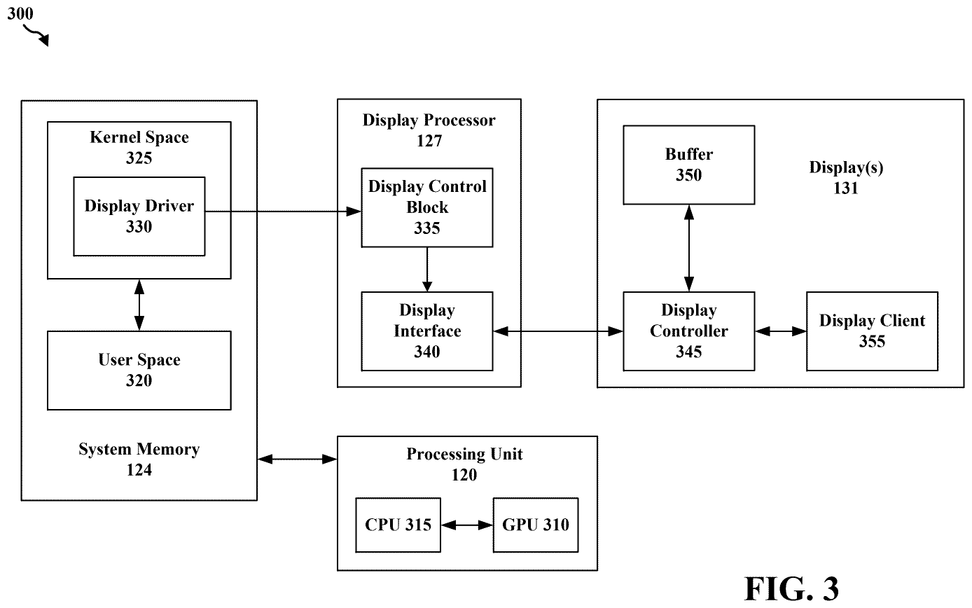

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

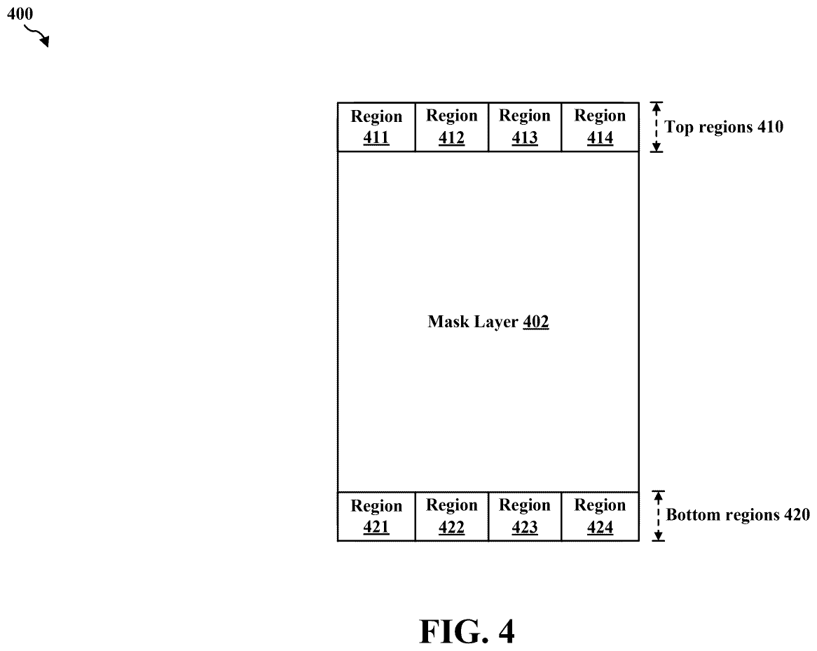

FIG. 4 is a diagram 400 illustrating an example mask layer for display processing. More specifically, diagram 400 depicts one type of mask layer that may represent portions of a display panel. As shown in FIG. 4, diagram 400 includes mask layer 402 including top regions 410 and bottom regions 420. Top regions 410 include region 411, region 412, region 413, and region 414, and bottom regions 420 include region 421, region 422, region 423, and region 424. As depicted in FIG. 4, mask layer 402 may represent the different regions that are displayed on a display panel.

Some types of displays may use a certain type of mask layer (e.g., a shape mask layer) to reshape a display frame. For instance, a mask layer may reshape the display frame to provide more optimized visual shapes at the display panel (e.g., improved round corners, improved circular shape, improved rectangular shape, etc.). These types of mask layers (e.g., shape mask layers) may be processed by software (e.g., graphics processing unit (GPU) software or central processing unit (CPU) software) or by hardware (e.g., display processing unit (DPU) hardware). Also, these mask layers may be processed by other specific types of hardware logic modules (e.g., modules in a display driver integrated circuit (DDIC) or bridge chips). In some aspects, these types of mask layers (e.g., shape mask layers) may be based on certain unit, such as a pixel. That is, the shape generation basis unit of the shape mask layers may be a single pixel.

Some aspects of display processing may utilize frame buffers to cache or store a composition output of a GPU. For instance, display layers may be cached or stored in a frame buffer after composition at a GPU. In some aspects, a composition hardware (HW) or software (SW) stack may use a frame buffer target to cache a composition output (e.g., a GPU composition output or a CPU composition output). The cached composition output may then be sent to another processor (e.g., a DPU) as an input layer. The frame buffer may have a number of different color formats, such as a red (R) green (G) blue (B) alpha (A) (RGBA) format (e.g., RGBA8888 format). Also, the frame buffer may be a certain size, (e.g., a 32-bit triple buffer). For example, at the beginning of a display/graphics subsystem design, a frame buffer may be created as an RGBA8888 format and a 32-bit triple buffer. In some instances, if the frame layers do not use a certain composition (e.g., a GPU or client composition), the frame buffers may be ignored. Also, the layers (e.g., frame layers or display layers associated with display processing) may be directly fetched and composed. For instance, a DPU or hardware composer may directly fetch the layers and then compose the layers.

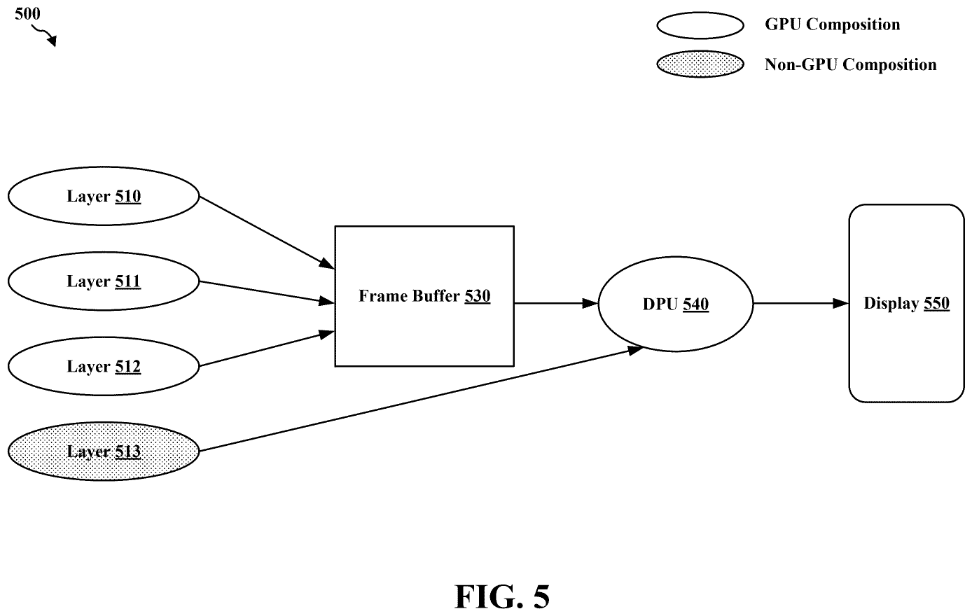

FIG. 5 is a diagram 500 illustrating an example of a layer composition scheme for display processing. More specifically, diagram 500 depicts a layer composition of display layers where certain layers (e.g., layers of a certain composition) are cached in a frame buffer, and some layers are directly fetched and composed by a DPU. As shown in FIG. 5, diagram 500 includes layer 510, layer 511, layer 512, layer 513, frame buffer 530 (e.g., an RGBA8888 format frame buffer), DPU 540, and display 550. FIG. 5 depicts that layers composed at a GPU (i.e., layers associated with GPU composition) may be cached or stored in a frame buffer. For example, layer 510, layer 511, and layer 512 may be composed at a GPU and then cached/stored at frame buffer 530. Alternatively, layers that are not composed at a GPU (i.e., layers associated with non-GPU composition) may be directly fetched and composed at a DPU. For instance, layer 513 may be directly fetched and composed at DPU 540. That is, layer 510, layer 511, and layer 512 may be a certain type of composition (e.g., GPU composition), while layer 513 may be another type of composition (non-GPU composition). After being cached/stored in frame buffer 530, the layer 510, layer 511, and layer 512 may be sent to DPU 540. Further, after processing at DPU 540, the layers 510-513 may be sent to display 550.

Some types of display processing devices (e.g., mobile devices, computers, TVs, or other consumer devices) may utilize complex multiple content layouts in a single display processing layer or multiple display processing layers. That is, for graphics or display stacks in operating systems of the devices, there may be a single display processing layer (i.e., display layer or layer that is associated with display processing) or multiple display processing layers. For instance, there may be at least one display layer that may be associated with a screen or frame for a display processing device, such that the display panel at the device may be divided amongst the display layers. Additionally, for content or end users, there may be multiple content entities in the display processing layer. This may be due to operating system limitations and/or application rendering/resource management limitations. Further, some types of applications may choose to render in using a single display processing layer. Color processing capability on a per-region basis (i.e., for each region of interest (ROI) in a layer) may be utilized with certain types of display processing unit (DPU) architecture.

Different types of DPU image processing (e.g., DPU per-layer flexible image processing) are utilized by current mobile consumer electronics devices. Based on the content of different layers, providing accurate per-layer image processing may be important to the perception of an end user. There may be a number of different types of per-layer image processing, such as video high dynamic range (HDR) layer tone mapping and processing and/or video standard dynamic range (SDR) layer visual contrast boosting. Types of per-layer image processing may also include proper tone mapping for photo image layers, game layer color processing and flexible visual control options provided to end users, flexible visual control options for video layers provided to end users, and flexible visual control options for texts/user interface (UI) layers provided to end users.

In some aspects of display processing, there may be a visual difference between DPU composition and GPU composition. For example, this visual difference may lead to display screen flickering or refresh problems, such as a jank (e.g., the result of the display application not being able to keep up with the refresh rate of the display). Further, the visual difference between DPU composition and GPU composition may result in visual artifacts in different types of scenarios. In some instances, DPU per-layer image processing may make this problem worse. For instance, DPU per-layer image processing visual effects may be reduced or eliminated after display layers switch or revert to GPU composition. With the advent of flexible DPU per-layer image processing usage in different scenarios, the problem of visual effects reduction or elimination associated with GPU composition may be an important issue.

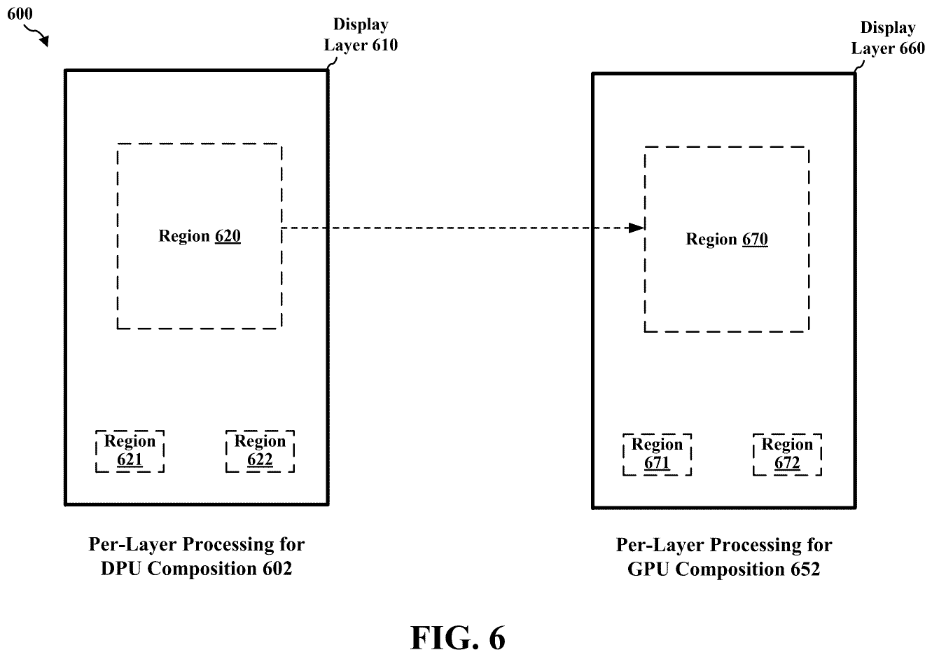

FIG. 6 is a diagram 600 illustrating an example of layer processing for DPU composition and GPU composition. For instance, diagram 600 depicts per-layer processing for DPU composition 602 for a display layer 610 (e.g., a layer of a certain composition) in a frame, where the layer includes different areas or regions of interest (ROIs). As shown in FIG. 6, display layer 610 includes region 620, region 621, and region 622. Each of the region 620, region 621, or region 622 may be associated with a region of interest (ROI) or an ROI for color processing. Also, diagram 600 depicts per-layer processing for GPU composition 652 for a display layer 660 (e.g., a layer of a certain composition) in a frame, where the layer includes different areas or ROIs. As shown in FIG. 6, display layer 660 includes region 670, region 671, and region 672. Each of the region 670, region 671, or region 672 may be associated with an ROI or an ROI for color processing. More specifically, diagram 600 shows that per-layer processing may be performed for DPU composition (e.g., DPU composition 602) and/or GPU composition (e.g., GPU composition 652). The per-layer processing for DPU composition 602 may be associated with image boosting (i.e., increasing the quality or pixel count of the image) or an increased number of visual effects. However, per-layer processing for GPU composition 652 may not be associated with image boosting or a decreased number of visual effects. Accordingly, the per-layer processing for DPU composition 602 may have increased visual effects compared to per-layer processing for GPU composition 652.

As indicated in FIG. 6, there may be a number of issues with per-layer image processing for both DPU composition and GPU composition. This problem may be challenging in both technique bottleneck and engineering efforts at display devices. One of the reasons for these issues is DPU per-layer processing pipelines may be complex and flexible. Implementing the same processing techniques in a GPU pipeline compared to a DPU pipeline may be difficult (e.g., this may need increased engineering efforts for GPU software, software application program interfaces (APIs), GPU drivers, and/or GPU hardware). Aligning GPU path processing with DPU path processing for per-layer image processing may need increased engineering efforts. Also, GPU processing may utilize an increased amount of power consumption and may lead to potential performance degradation. The ability to optimize power and/or performance at a GPU in different scenarios may be a challenge. For instance, high definition (e.g., HDR10) video tone mapping and processing in GPUs may need increased engineering efforts, as there are a lot of limitations in power, performance, and/or visual quality. Accordingly, it may be beneficial to align GPU per-layer processing with DPU per-layer processing. For instance, it may be beneficial to have similar visual effects or image boosting for per-layer processing for GPU composition compared to per-layer processing for DPU composition.

Aspects of the present disclosure may align GPU per-layer processing with DPU per-layer processing. That is, aspects presented herein may provide for similar visual effects or image boosting for per-layer processing for GPU composition compared to per-layer processing for DPU composition. For instance, aspects of the present disclosure may implement the same processing techniques in a GPU pipeline compared to a DPU pipeline. Additionally, aspects of the present disclosure may align GPU path processing with DPU path processing for per-layer image processing. Further, aspects of the present disclosure may optimize power and/or performance for per-layer image processing at a GPU compared to per-layer image processing at a DPU. For example, aspects presented herein may provide high definition or HDR video tone mapping and processing for both GPUs and DPUs.

In some instances, aspects of the present disclosure may analyze a layer stack (e.g., a stack of display layers) for a current frame or a screen at a display device. Additionally, in some instances, aspects of the present disclosure may be associated with a CPU, a DPU driver, a DPU, or a GPU. Also, aspects presented herein may identify display layers that may need DPU-specific processing and/or may be composed by GPU (e.g., an operating system (OS) framework). After doing so, aspects presented herein may mark those layers as DPU-interested layers (i.e., layers that are to be processed at a DPU). Aspects presented herein may also determine whether each of the display layers is a rotation animation layer or a non-rotation animation layer. A “rotation animation layer” or “rotational animation layer” may refer to a layer that rotates during animation (e.g., animation at a DPU or a GPU) or a layer that is associated with an animation frame. A “non-rotation animation layer” or “non-rotational animation layer” may refer to a layer that does not rotate during animation (e.g., animation at a DPU or a GPU) or a layer that is associated with a non-animation frame. Additionally, aspects presented herein may identify non-rotation animation layers by determining whether coordinates/shapes of interested layers have any changes or not. If the interested layers correspond to a change in coordinates/shape, the layer may be a rotation animation layer or may be associated with an animation frame.

In some aspects, for non-rotation animation layers, aspects presented herein may divide a frame buffer (e.g., a GPU composition output frame buffer) into different regions of interest (ROIs). A frame buffer may also be referred to as a “framebuffer” or any other appropriate term. For example, for non-rotation animation layers, aspects presented herein (e.g., a CPU or DPU driver) may split a frame buffer (e.g., a GPU output) into multiple composition stages and then apply regional processing. As indicated herein, interested layers may be included in a region of DPU-interested layers (i.e., an ROI). DPU-interested layers may refer to layers are to be processed at a DPU. For each individual DPU-interested layer, aspects presented herein may assign one ROI. If certain ROIs are overlapping, aspects presented herein assign an ROI following a layer hierarchy or display hierarchy (i.e., a Z order or Z-order). Aspects presented herein may also assign a region of DPU non-interested layers (i.e., layers that may not be processed at a DPU).

Moreover, for each ROI in a frame buffer, the ROI may be assigned to one individual composition stage and assigned to one DPU per-layer processor or component in a DPU pipeline (e.g., a processing pipe or source surface processor pipe (SSPP)). The ROI may be assigned to the composition stage or DPU per-layer processor for a specified color/image post-processing, a three-dimensional (3D) lookup table (LUT), or other detail enhancement. The ROI for DPU-interested layers may be assigned to a higher layer hierarchy or display hierarchy (i.e., a Z order or Z-order). In the subsequent composition stages, an entire frame buffer (e.g., a frame buffer excluding previous ROI regions) may be fetched and composed at a lower layer hierarchy or display hierarchy (e.g., a layer hierarchy for the background). Also, the frame buffer may be split into multiple ROIs and/or additional composition stages may be added for sub-framebuffer regions (e.g., logically added new sub-framebuffer regions). In some aspects, the ROI-specified regional processing may be determined by DPU-interested layer hierarchy (e.g., Z order), a blending mode, and/or a layer's original processing configurations. For instance, the ROI-specified regional processing for a layer may be determined if the DPU-interested layer is on the top of a regional layer stack and/or the layer has a constant blending value (i.e., blending alpha value). Also, the ROI-specified regional processing for a layer may be determined if the DPU-interested layer is not on the top of a regional layer stack and the layer is covered by one or more transparent layers. In some instances, the DPU-interested layer original processing configuration may correspond to the ROI-specified regional processing. In other instances, aspects presented herein may drop the layer's original processing configurations. For instance, a first layer may be associated with a first color temperature adjustment configuration, which may be applied to the framebuffer ROI by a DPU per-layer processor (e.g., a processing pipe or an SSPP).

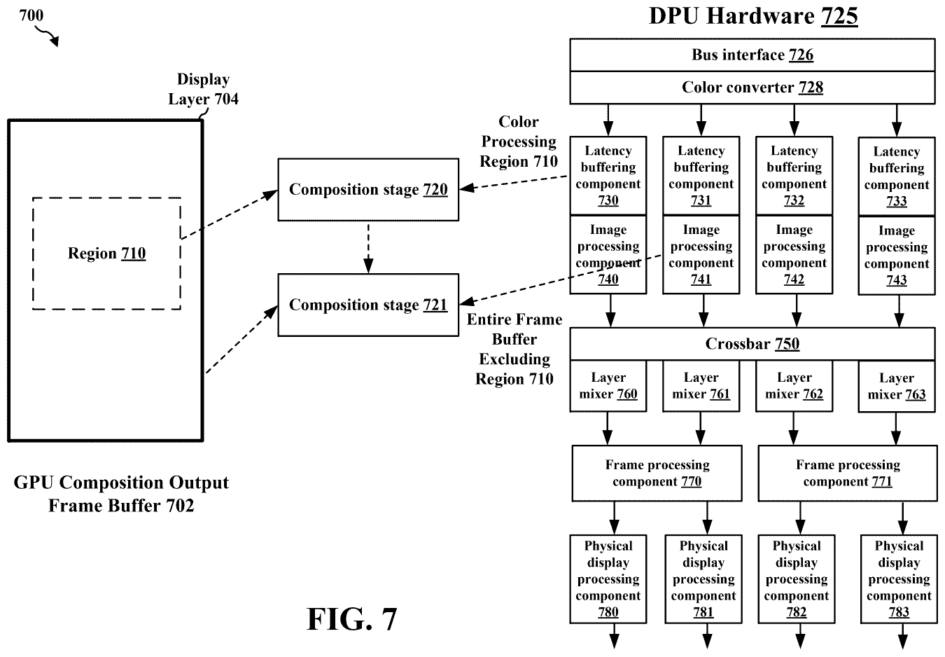

FIG. 7 is a diagram 700 illustrating an example of a composition scheme for display processing. More specifically, diagram 700 depicts a composition scheme for a frame buffer 702 (e.g., a GPU composition output frame buffer), where diagram 700 includes a display layer 704 with an ROI, different composition stages, and corresponding components in DPU hardware 725. As shown in FIG. 7, diagram 700 includes display layer 704 with a region (e.g., region 710), as well as multiple composition stages (e.g., composition stage 720 and composition stage 721). Region 710 may be an ROI or DPU-interested ROI (i.e., an ROI corresponding to processing at a DPU). Also, as illustrated in FIG. 7, DPU hardware 725 includes bus interface 726, color converter 728, multiple latency buffering components (e.g., latency buffering component 730, latency buffering component 731, latency buffering component 732, and latency buffering component 733) and multiple image processing components (e.g., image processing component 740, image processing component 741, image processing component 742, and image processing component 743). DPU hardware 725 also includes crossbar 750, multiple layer mixers (e.g., layer mixer 760, layer mixer 761, layer mixer 762, and layer mixer 763), multiple frame processing components (e.g., frame processing component 770 and frame processing component 771), and multiple physical display processing components (e.g., physical display processing component 780, physical display processing component 781, physical display processing component 782, and physical display processing component 783). In some aspects, the latency buffering components or image processing component may correspond to a processing pipe or a source surface processor pipe (SSPP) in a DPU.

As depicted in FIG. 7, the display layer 704 may be included in multiple layers that are obtained from a GPU, an application, or a game. For instance, a CPU may obtain an indication of a plurality of layers (including display layer 704) that are associated with at least one frame, where each layer of the plurality of layers includes a set of layer regions or ROIs (e.g., one or more layer regions or ROIs), and where each of the set of layer regions or ROIs include a plurality of pixels. Each of the layer regions in display layer 704 (e.g., region 710) may correspond to a specific component in DPU hardware 725 (e.g., one of the latency buffering components 730-733 or the image processing components 740-743) and/or a specific composition stage (e.g., one of composition stages 720-721). For instance, each of a set of layer regions may be assigned to a corresponding component in a set of components in a DPU pipeline. For example, region 710 may be assigned or allocated to latency buffering component 730 or image processing component 740. Also, the frame buffer 702 (excluding region 710) may be assigned or allocated to latency buffering component 731 or image processing component 741.

As shown in FIG. 7, the regions or ROIs may also be associated with a specific composition stage. For example, region 710 may be associated with composition stage 720, and frame buffer 702 (excluding region 710) may be associated with composition stage 721. The composition stage may also be associated with the corresponding component in DPU hardware 725. For instance, the corresponding component may be associated with a composition stage (e.g., composition stages 720-721) for a specific color processing region (e.g., region 710). For example, latency buffering component 730 or image processing component 740 may be associated with composition stage 720 for region 710 (e.g., a color processing region), and latency buffering component 731 or image processing component 741 may be associated with composition stage 721 for frame buffer 702 (excluding region 710). The color processing regions may be associated with a processing pipe or a source surface processor pipe (SSPP) in a DPU, as well as correspond to an adjusted color temperature. As indicated in FIG. 7, the entire frame buffer 702 excluding the regions or ROIs (e.g., region 710) may be associated with a corresponding component (e.g., latency buffering component 731 or image processing component 741), as well as a composition stage (e.g., composition stage 721). The composition stage (composition stages 720-721) may include a blending stage, such that composing the set of layer regions or ROIs may include: blending at least some of the set of layer regions or ROIs. Moreover, as depicted in FIG. 7, the frame buffer 702 may correspond to a composition output at a GPU.

Additionally, aspects presented herein may analyze a layer stack of a current frame and identify layers that may need DPU-specific processing and/or are planned to be composed by GPU (OS framework). After doing so, aspects presented herein may mark those layers as DPU-interested layers. Aspects presented herein may also identify non-animation layers (or layers associated with non-animation frames) by determining whether coordinates/shapes of interested layers have any changes or not. If the interested layers correspond to a change or adjustment in coordinates/shape, the layer may be a rotation animation layer or may be associated with an animation frame. For animation layers or layers associated with animation frames, aspects presented herein may apply layer original processing to an entire frame buffer. For instance, aspects presented herein may apply layer original processing to an entire frame buffer if a DPU-interested layer size is larger than a threshold (e.g., larger that a size ratio for the entire frame). If the layer size ratio of the whole frame is greater than a threshold (e.g., a layer size ratio of 0.75), aspects presented herein may apply the original processing to the entire frame buffer.

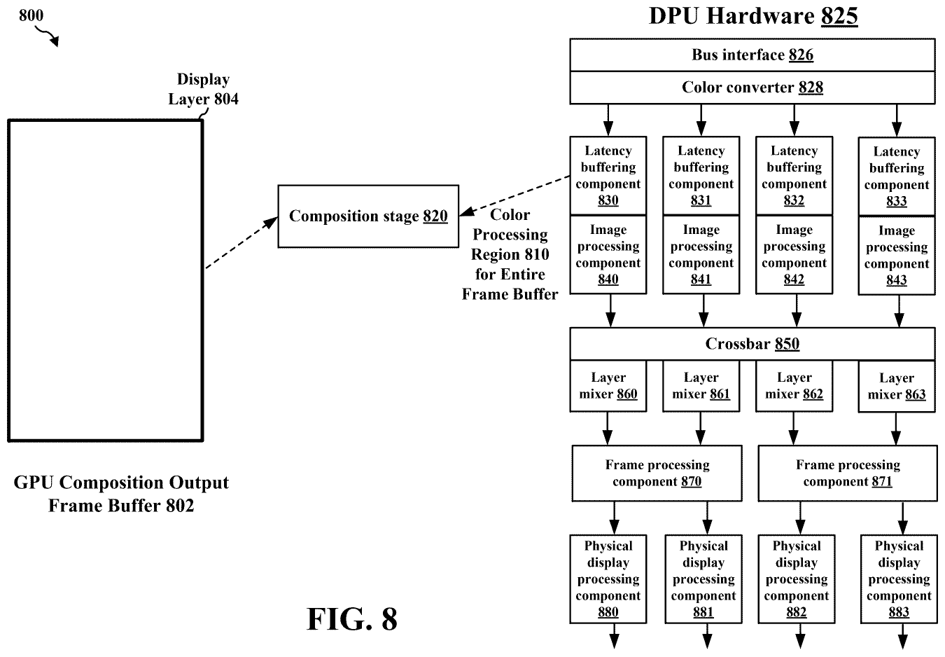

FIG. 8 is a diagram 800 illustrating an example of a composition scheme for display processing. More specifically, diagram 800 depicts a composition scheme for a frame buffer 802 (e.g., a GPU composition output frame buffer), where diagram 800 includes a display layer 804, a composition stage, and corresponding components in DPU hardware 825. As shown in FIG. 8, diagram 800 includes display layer 804, as well as a composition stage (e.g., composition stage 820). Also, as illustrated in FIG. 8, DPU hardware 825 includes bus interface 826, color converter 828, multiple latency buffering components (e.g., latency buffering component 830, latency buffering component 831, latency buffering component 832, and latency buffering component 833) and multiple image processing components (e.g., image processing component 840, image processing component 841, image processing component 842, and image processing component 843). DPU hardware 825 also includes crossbar 850, multiple layer mixers (e.g., layer mixer 860, layer mixer 861, layer mixer 862, and layer mixer 863), multiple frame processing components (e.g., frame processing component 870 and frame processing component 871), and multiple physical display processing components (e.g., physical display processing component 880, physical display processing component 881, physical display processing component 882, and physical display processing component 883). In some aspects, the latency buffering components or image processing component may correspond to a processing pipe or a source surface processor pipe (SSPP) in a DPU.

As depicted in FIG. 8, the display layer 804 may be included in multiple layers that are obtained from a GPU, an application, or a game. For instance, a CPU may obtain an indication of a plurality of layers (including display layer 804) that are associated with at least one frame, where each layer of the plurality of layers includes a plurality of pixels. The display layer 804 or frame buffer 802 may correspond to a specific component in DPU hardware 825 (e.g., one of the latency buffering components 830-833 or the image processing components 840-843) and/or a specific composition stage (e.g., composition stage 820). For instance, the display layer 804 or frame buffer 802 may be assigned to a corresponding component in a set of components in a DPU pipeline. For example, the display layer 804 may be assigned or allocated to latency buffering component 830 or image processing component 840. Also, the entire frame buffer 802 may be assigned or allocated to latency buffering component 830 or image processing component 840.

As shown in FIG. 8, the display layer or frame buffer may be associated with a specific composition stage. For example, display layer 804 or frame buffer 802 may be associated with composition stage 820. The composition stage may also be associated with the corresponding component in DPU hardware 825. For instance, the corresponding component may be associated with a composition stage (e.g., composition stage 820) for a specific color processing region (e.g., region 810) for the entire frame buffer. For example, latency buffering component 830 or image processing component 840 may be associated with composition stage 820 for region 810 (e.g., a color processing region) for frame buffer 802. The color processing regions may be associated with a processing pipe or an SSPP in a DPU, as well as correspond to an adjusted color temperature for the entire frame. As indicated in FIG. 8, the entire frame buffer 802 may be associated with a corresponding component (e.g., latency buffering component 830 or image processing component 840), as well as a composition stage (e.g., composition stage 820). The composition stage (composition stage 820) may include a blending stage, such that a composition associated with the layer or frame buffer may include: blending the layer or frame buffer. Moreover, as depicted in FIG. 8, the frame buffer 802 may correspond to a composition output at a GPU.

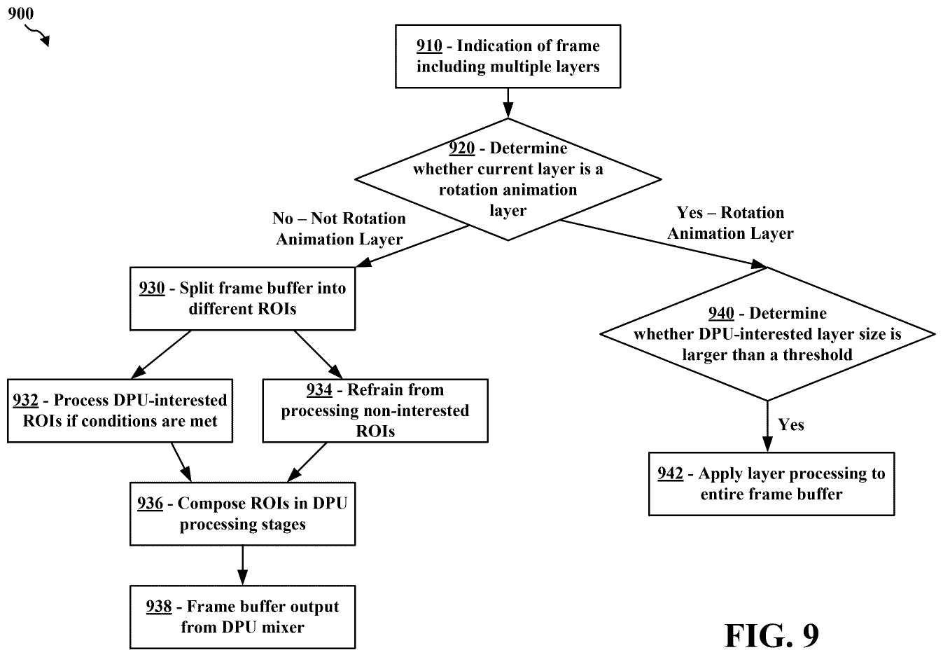

FIG. 9 is a diagram 900 illustrating an example of a flowchart for display layer processing associated with DPU composition and GPU composition. As shown in FIG. 9, at 910, aspects presented herein (e.g., a CPU or DPU driver) may obtain an indication of a frame including multiple layers. At 920, aspects presented herein may determine whether a current layer is a rotation animation layer. If the determination at 920 results in a determination that the layer is not a rotation animation layer, at 930, aspects presented herein may split a frame buffer into different regions or ROIs. After splitting the frame buffer into different ROIs, at 932, aspects presented herein may process DPU-interested regions or ROIs if certain conditions are met. Also, at 934, aspects presented herein may refrain from processing non-interested ROIs. At 936, aspects presented herein may compose ROIs in DPU processing stages. At 938, the composed ROIs may correspond to a frame buffer output from a DPU mixer. If the determination at 920 results in a determination that the layer is a rotation animation layer, at 940, aspects presented herein may determine whether a DPU-interested layer size is larger than a threshold. If so, at 942, aspects presented herein may apply layer processing to the entire frame buffer.

Aspects of the present disclosure may include a number of benefits or advantages. For instance, aspects presented herein may divide a GPU composition output frame buffer and re-compose the divided sections of the GPU composition output frame buffer. Aspects presented herein may also conditionally apply DPU processing to frame buffer regions. Additionally, in some instances, aspects of the present disclosure may align GPU per-layer processing with DPU per-layer processing. That is, aspects presented herein may provide for similar visual effects or image boosting for per-layer processing for GPU composition compared to per-layer processing for DPU composition. For instance, aspects of the present disclosure may implement the same processing techniques in a GPU pipeline compared to a DPU pipeline. Additionally, aspects of the present disclosure may align GPU path processing with DPU path processing for per-layer image processing. Further, aspects of the present disclosure may optimize power and/or performance for per-layer image processing at a GPU compared to per-layer image processing at a DPU. For example, aspects presented herein may provide high definition or HDR video tone mapping and processing for both GPUs and DPUs. Moreover, aspects presented herein may cover GPU composition scenarios associated with DPU per-layer processing. For instance, aspects presented herein may be applicable to certain types of GPU composition (e.g., floating windows, floating buttons, animations, etc.). Aspects presented herein may result in an optimized visual quality for display layers. Also, aspects presented herein may provide a fallback optimization for DPU per-layer processing and GPU per-layer processing.

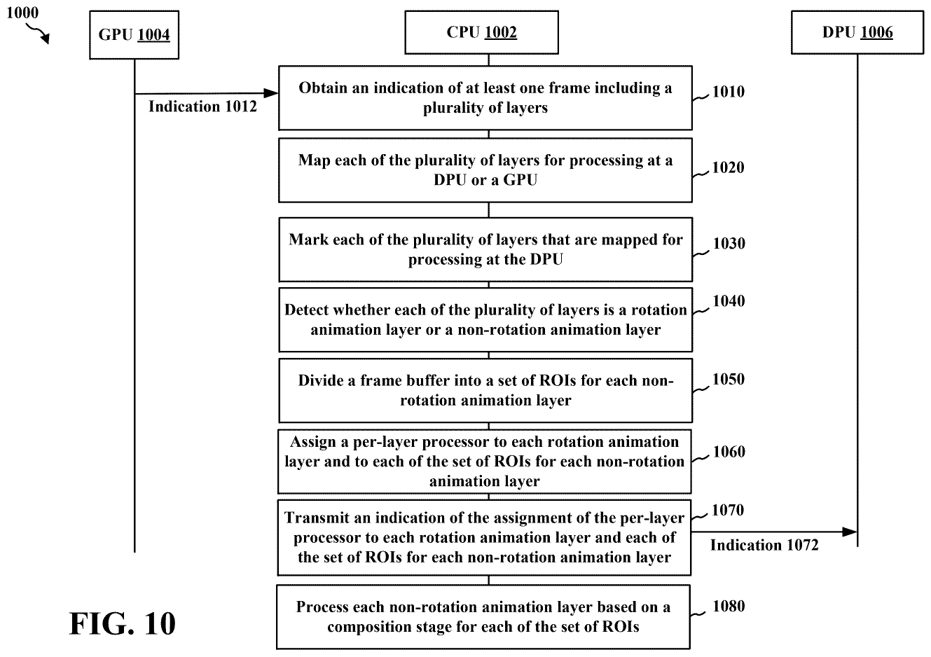

FIG. 10 is a communication flow diagram 1000 of display processing in accordance with one or more techniques of this disclosure. As shown in FIG. 10, diagram 1000 includes example communications between CPU 1002 (e.g., a DPU driver, other central processor, or display processor), GPU 1004, and DPU 1006, in accordance with one or more techniques of this disclosure.

At 1010, CPU 1002 may obtain an indication of at least one frame including a plurality of layers (e.g., CPU 1002 may obtain indication 1012 from GPU 1004), where the at least one frame is associated with the display processing. In some instances, the plurality of layers may be associated with a layer stack or a regional layer stack.

At 1020, CPU 1002 may map each of the plurality of layers for processing at a display processing unit (DPU) or a graphics processing unit (GPU).

At 1030, CPU 1002 may mark, based on mapping each of the plurality of layers for the processing at the DPU or the GPU, each of the plurality of layers that are mapped for the processing at the DPU.

At 1040, CPU 1002 may detect whether each of the plurality of layers is a rotation animation layer or a non-rotation animation layer based on the mapping for each of the plurality of layers. In some aspects, detecting whether each of the plurality of layers is a rotation animation layer or a non-rotation animation layer may include: identifying whether a set of coordinates and shapes for each of the plurality of layers includes an adjustment. For instance, the CPU may identify whether a set of coordinates and shapes for each of the plurality of layers includes an adjustment. Also, each rotation animation layer in the plurality of layers may include the set of coordinates and shapes with the adjustment, and each non-rotation animation layer in the plurality of layers may include the set of coordinates and shapes without the adjustment. A rotation animation layer may be a layer that rotates during an animation at the DPU or the GPU, and a non-rotation animation layer may be a layer that does not rotate during the animation at the DPU or the GPU.

At 1050, CPU 1002 may divide a frame buffer into a set of regions of interest (ROIs) for each non-rotation animation layer in the plurality of layer. The frame buffer may correspond to a composition output at the GPU.

At 1060, CPU 1002 may assign a first per-layer processor at the DPU to each rotation animation layer in the plurality of layers or at least one second per-layer processor at the DPU to each of the set of ROIs in the frame buffer for each non-rotation animation layer in the plurality of layers. The first per-layer processor may correspond to a first composition stage for each rotation animation layer in the plurality of layers, and the at least one second per-layer processor may correspond to a second composition stage for each of the set of ROIs in the frame buffer. Also, each of the set of ROIs may be assigned a higher composition priority compared to other ROIs in the set of ROIs for each non-rotation animation layer in the plurality of layers. In some aspects, the first per-layer processor at the DPU may be assigned to each rotation animation layer in the plurality of layers if an available layer size at the DPU is greater than a layer size threshold. The layer size threshold may be configurable or adjustable by a central processing unit (CPU).

At 1070, CPU 1002 may transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers (e.g., CPU 1002 may transmit indication 1072 to DPU 1006).

At 1080, CPU 1002 may process each non-rotation animation layer in the plurality of layers based on the second composition stage for each of the set of ROIs in the frame buffer. In some aspects, processing each non-rotation animation layer in the plurality of layers based on the second composition stage may include: blending each non-rotation animation layer in the plurality of layers based on the second composition stage. For instance, the CPU may blend each non-rotation animation layer in the plurality of layers based on the second composition stage. Each non-rotation animation layer in the plurality of layers may be processed if at least one of: (i) the non-rotation animation layer is on top of a regional layer stack and the non-rotation animation layer has a constant blending alpha value, or (ii) the non-rotation animation layer is not on top of the regional layer stack and the non-rotation animation layer is covered by one or more transparent layers. Also, each non-rotation animation layer in the plurality of layers may be associated with a color configuration adjustment or a color-related adjustment.

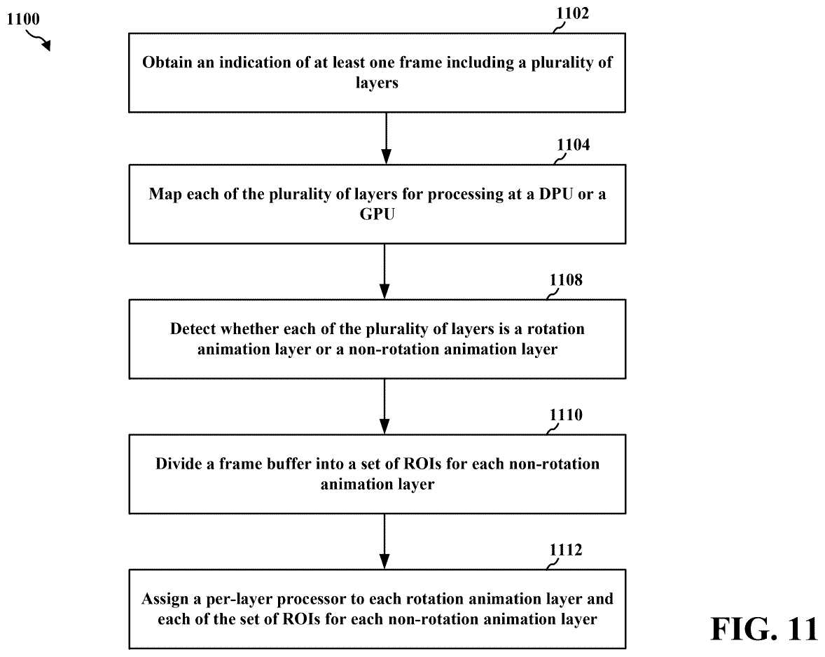

FIG. 11 is a flowchart 1100 of an example method of display processing in accordance with one or more techniques of this disclosure. The method may be performed by a CPU (or other central processor), a DPU driver, a DPU (or other display processor), a GPU (or other graphics processor), a DDIC, an apparatus for display processing, a wireless communication device, and/or any apparatus that may perform display processing as used in connection with the examples of FIGS. 1-10.

At 1102, the CPU may obtain an indication of at least one frame including a plurality of layers, where the at least one frame is associated with the display processing, as described in connection with the examples in FIGS. 1-10. For example, as described in 1010 of FIG. 10, CPU 1002 may obtain an indication of at least one frame including a plurality of layers, where the at least one frame is associated with the display processing. Further, step 1102 may be performed by display processor 127 in FIG. 1. In some instances, the plurality of layers may be associated with a layer stack or a regional layer stack.

At 1104, the CPU may map each of the plurality of layers for processing at a display processing unit (DPU) or a graphics processing unit (GPU), as described in connection with the examples in FIGS. 1-10. For example, as described in 1020 of FIG. 10, CPU 1002 may map each of the plurality of layers for processing at a display processing unit (DPU) or a graphics processing unit (GPU). Further, step 1104 may be performed by display processor 127 in FIG. 1.

At 1108, the CPU may detect whether each of the plurality of layers is a rotation animation layer or a non-rotation animation layer based on the mapping for each of the plurality of layers, as described in connection with the examples in FIGS. 1-10. For example, as described in 1040 of FIG. 10, CPU 1002 may detect whether each of the plurality of layers is a rotation animation layer or a non-rotation animation layer based on the mapping for each of the plurality of layers. Further, step 1108 may be performed by display processor 127 in FIG. 1. In some aspects, detecting whether each of the plurality of layers is a rotation animation layer or a non-rotation animation layer may include: identifying whether a set of coordinates and shapes for each of the plurality of layers includes an adjustment. For instance, the CPU may identify whether a set of coordinates and shapes for each of the plurality of layers includes an adjustment. Also, each rotation animation layer in the plurality of layers may include the set of coordinates and shapes with the adjustment, and each non-rotation animation layer in the plurality of layers may include the set of coordinates and shapes without the adjustment. A rotation animation layer may be a layer that rotates during an animation at the DPU or the GPU, and a non-rotation animation layer may be a layer that does not rotate during the animation at the DPU or the GPU.

At 1110, the CPU may divide a frame buffer into a set of regions of interest (ROIs) for each non-rotation animation layer in the plurality of layer, as described in connection with the examples in FIGS. 1-10. For example, as described in 1050 of FIG. 10, CPU 1002 may divide a frame buffer into a set of regions of interest (ROIs) for each non-rotation animation layer in the plurality of layer. Further, step 1110 may be performed by display processor 127 in FIG. 1. The frame buffer may correspond to a composition output at the GPU.

At 1112, the CPU may assign a first per-layer processor at the DPU to each rotation animation layer in the plurality of layers or at least one second per-layer processor at the DPU to each of the set of ROIs in the frame buffer for each non-rotation animation layer in the plurality of layers, as described in connection with the examples in FIGS. 1-10. For example, as described in 1060 of FIG. 10, CPU 1002 may assign a first per-layer processor at the DPU to each rotation animation layer in the plurality of layers or at least one second per-layer processor at the DPU to each of the set of ROIs in the frame buffer for each non-rotation animation layer in the plurality of layers. Further, step 1112 may be performed by display processor 127 in FIG. 1. The first per-layer processor may correspond to a first composition stage for each rotation animation layer in the plurality of layers, and the at least one second per-layer processor may correspond to a second composition stage for each of the set of ROIs in the frame buffer. Also, each of the set of ROIs may be assigned a higher composition priority compared to other ROIs in the set of ROIs for each non-rotation animation layer in the plurality of layers. In some aspects, the first per-layer processor at the DPU may be assigned to each rotation animation layer in the plurality of layers if an available layer size at the DPU is greater than a layer size threshold. The layer size threshold may be configurable or adjustable by a central processing unit (CPU).

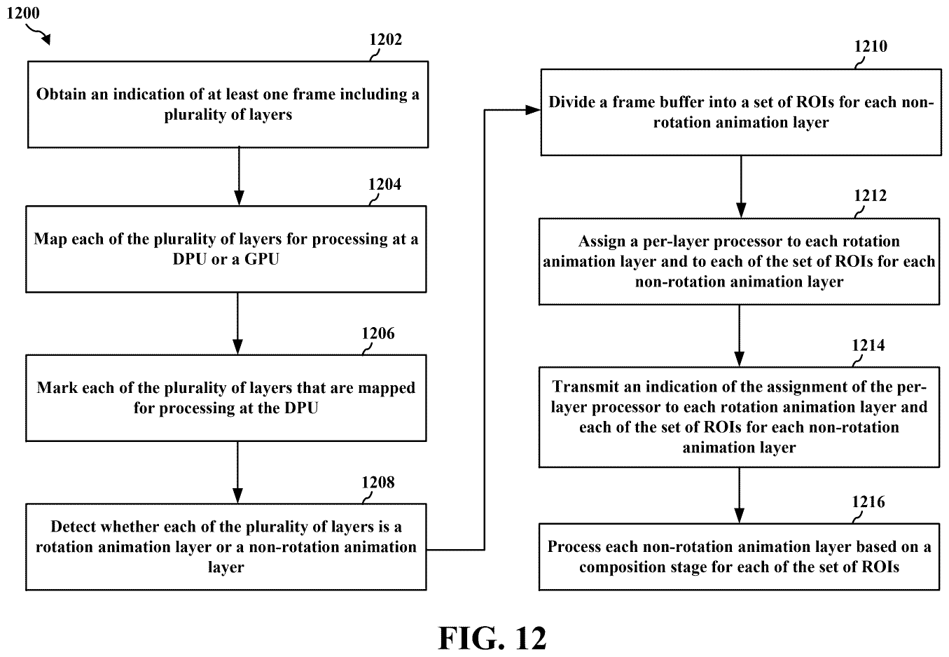

FIG. 12 is a flowchart 1200 of an example method of display processing in accordance with one or more techniques of this disclosure. The method may be performed by a CPU (or other central processor), a DPU driver, a DPU (or other display processor), a GPU (or other graphics processor), a DDIC, an apparatus for display processing, a wireless communication device, and/or any apparatus that may perform display processing as used in connection with the examples of FIGS. 1-10.

At 1202, the CPU may obtain an indication of at least one frame including a plurality of layers, where the at least one frame is associated with the display processing, as described in connection with the examples in FIGS. 1-10. For example, as described in 1010 of FIG. 10, CPU 1002 may obtain an indication of at least one frame including a plurality of layers, where the at least one frame is associated with the display processing. Further, step 1202 may be performed by display processor 127 in FIG. 1. In some instances, the plurality of layers may be associated with a layer stack or a regional layer stack.

At 1204, the CPU may map each of the plurality of layers for processing at a display processing unit (DPU) or a graphics processing unit (GPU), as described in connection with the examples in FIGS. 1-10. For example, as described in 1020 of FIG. 10, CPU 1002 may map each of the plurality of layers for processing at a display processing unit (DPU) or a graphics processing unit (GPU). Further, step 1204 may be performed by display processor 127 in FIG. 1.

At 1206, the CPU may mark, based on mapping each of the plurality of layers for the processing at the DPU or the GPU, each of the plurality of layers that are mapped for the processing at the DPU, as described in connection with the examples in FIGS. 1-10. For example, as described in 1030 of FIG. 10, CPU 1002 may mark, based on mapping each of the plurality of layers for the processing at the DPU or the GPU, each of the plurality of layers that are mapped for the processing at the DPU. Further, step 1206 may be performed by display processor 127 in FIG. 1.

At 1208, the CPU may detect whether each of the plurality of layers is a rotation animation layer or a non-rotation animation layer based on the mapping for each of the plurality of layers, as described in connection with the examples in FIGS. 1-10. For example, as described in 1040 of FIG. 10, CPU 1002 may detect whether each of the plurality of layers is a rotation animation layer or a non-rotation animation layer based on the mapping for each of the plurality of layers. Further, step 1208 may be performed by display processor 127 in FIG. 1. In some aspects, detecting whether each of the plurality of layers is a rotation animation layer or a non-rotation animation layer may include: identifying whether a set of coordinates and shapes for each of the plurality of layers includes an adjustment. For instance, the CPU may identify whether a set of coordinates and shapes for each of the plurality of layers includes an adjustment. Also, each rotation animation layer in the plurality of layers may include the set of coordinates and shapes with the adjustment, and each non-rotation animation layer in the plurality of layers may include the set of coordinates and shapes without the adjustment. A rotation animation layer may be a layer that rotates during an animation at the DPU or the GPU, and a non-rotation animation layer may be a layer that does not rotate during the animation at the DPU or the GPU.

At 1210, the CPU may divide a frame buffer into a set of regions of interest (ROIs) for each non-rotation animation layer in the plurality of layer, as described in connection with the examples in FIGS. 1-10. For example, as described in 1050 of FIG. 10, CPU 1002 may divide a frame buffer into a set of regions of interest (ROIs) for each non-rotation animation layer in the plurality of layer. Further, step 1210 may be performed by display processor 127 in FIG. 1. The frame buffer may correspond to a composition output at the GPU.

At 1212, the CPU may assign a first per-layer processor at the DPU to each rotation animation layer in the plurality of layers or at least one second per-layer processor at the DPU to each of the set of ROIs in the frame buffer for each non-rotation animation layer in the plurality of layers, as described in connection with the examples in FIGS. 1-10. For example, as described in 1060 of FIG. 10, CPU 1002 may assign a first per-layer processor at the DPU to each rotation animation layer in the plurality of layers or at least one second per-layer processor at the DPU to each of the set of ROIs in the frame buffer for each non-rotation animation layer in the plurality of layers. Further, step 1212 may be performed by display processor 127 in FIG. 1. The first per-layer processor may correspond to a first composition stage for each rotation animation layer in the plurality of layers, and the at least one second per-layer processor may correspond to a second composition stage for each of the set of ROIs in the frame buffer. Also, each of the set of ROIs may be assigned a higher composition priority compared to other ROIs in the set of ROIs for each non-rotation animation layer in the plurality of layers. In some aspects, the first per-layer processor at the DPU may be assigned to each rotation animation layer in the plurality of layers if an available layer size at the DPU is greater than a layer size threshold. The layer size threshold may be configurable or adjustable by a central processing unit (CPU).

At 1214, the CPU may transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers, as described in connection with the examples in FIGS. 1-10. For example, as described in 1070 of FIG. 10, CPU 1002 may transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers. Further, step 1214 may be performed by display processor 127 in FIG. 1.

At 1216, the CPU may process each non-rotation animation layer in the plurality of layers based on the second composition stage for each of the set of ROIs in the frame buffer, as described in connection with the examples in FIGS. 1-10. For example, as described in 1080 of FIG. 10, CPU 1002 may process each non-rotation animation layer in the plurality of layers based on the second composition stage for each of the set of ROIs in the frame buffer. Further, step 1216 may be performed by display processor 127 in FIG. 1. In some aspects, processing each non-rotation animation layer in the plurality of layers based on the second composition stage may include: blending each non-rotation animation layer in the plurality of layers based on the second composition stage. For instance, the CPU may blend each non-rotation animation layer in the plurality of layers based on the second composition stage. Each non-rotation animation layer in the plurality of layers may be processed if at least one of: (i) the non-rotation animation layer is on top of a regional layer stack and the non-rotation animation layer has a constant blending alpha value, or (ii) the non-rotation animation layer is not on top of the regional layer stack and the non-rotation animation layer is covered by one or more transparent layers. Also, each non-rotation animation layer in the plurality of layers may be associated with a color configuration adjustment or a color-related adjustment.

In configurations, a method or an apparatus for display processing is provided. The apparatus may be a CPU (or other central processor), a DPU (or other display processor), a GPU (or other graphics processor), a DPU driver, a DDIC, an apparatus for display processing, and/or some other processor that may perform display processing. In aspects, the apparatus may be the display processor 127 within the device 104, or may be some other hardware within the device 104 or another device. The apparatus, e.g., display processor 127, may include means for obtaining an indication of at least one frame including a plurality of layers, where the at least one frame is associated with the display processing. The apparatus, e.g., display processor 127, may also include means for mapping each of the plurality of layers for processing at a display processing unit (DPU) or a graphics processing unit (GPU). The apparatus, e.g., display processor 127, may also include means for detecting whether each of the plurality of layers is a rotation animation layer or a non-rotation animation layer based on the mapping for each of the plurality of layers. The apparatus, e.g., display processor 127, may also include means for dividing a frame buffer into a set of regions of interest (ROIs) for each non-rotation animation layer in the plurality of layers. The apparatus, e.g., display processor 127, may also include means for assigning a first per-layer processor at the DPU to each rotation animation layer in the plurality of layers or at least one second per-layer processor at the DPU to each of the set of ROIs in the frame buffer for each non-rotation animation layer in the plurality of layers. The apparatus, e.g., display processor 127, may also include means for processing each non-rotation animation layer in the plurality of layers based on the second composition stage for each of the set of ROIs in the frame buffer. The apparatus, e.g., display processor 127, may also include means for marking, based on mapping each of the plurality of layers for the processing at the DPU or the GPU, each of the plurality of layers that are mapped for the processing at the DPU. The apparatus, e.g., display processor 127, may also include means for transmitting a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers.

The subject matter described herein may be implemented to realize one or more benefits or advantages. For instance, the described display processing techniques may be used by a CPU, a central processor, a DPU driver, a DPU, a display processor, a GPU, or some other processor that may perform display processing to implement the composition techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize composition techniques in order to improve memory bandwidth efficiency and/or increase processing speed at a CPU, a DPU or a GPU.

It is understood that the specific order or hierarchy of blocks in the processes / flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is an apparatus for display processing, including a memory and at least one processor coupled to the memory and, based at least in part on information stored in the memory, the at least one processor is configured to: obtain an indication of at least one frame including a plurality of layers, where the at least one frame is associated with the display processing; map each of the plurality of layers for processing at a display processing unit (DPU) or a graphics processing unit (GPU); detect whether each of the plurality of layers is a rotation animation layer or a non-rotation animation layer based on the mapping for each of the plurality of layers; divide a frame buffer into a set of regions of interest (ROIs) for each non-rotation animation layer in the plurality of layers; and assign a first per-layer processor at the DPU to each rotation animation layer in the plurality of layers or at least one second per-layer processor at the DPU to each of the set of ROIs in the frame buffer for each non-rotation animation layer in the plurality of layers.
Aspect 2 is the apparatus of aspect 1, where the first per-layer processor corresponds to a first composition stage for each rotation animation layer in the plurality of layers, and where the at least one second per-layer processor corresponds to a second composition stage for each of the set of ROIs in the frame buffer.
Aspect 3 is the apparatus of aspect 2, where the at least one processor is further configured to: process each non-rotation animation layer in the plurality of layers based on the second composition stage for each of the set of ROIs in the frame buffer.
Aspect 4 is the apparatus of aspect 3, where to process each non-rotation animation layer in the plurality of layers based on the second composition stage, the at least one processor is configured to: blend each non-rotation animation layer in the plurality of layers based on the second composition stage.
Aspect 5 is the apparatus of aspect 3, where each non-rotation animation layer in the plurality of layers is processed if at least one of: (i) the non-rotation animation layer is on top of a regional layer stack and the non-rotation animation layer has a constant blending alpha value, or (ii) the non-rotation animation layer is not on top of the regional layer stack and the non-rotation animation layer is covered by one or more transparent layers.
Aspect 6 is the apparatus of aspect 3, where each non-rotation animation layer in the plurality of layers is associated with a color configuration adjustment or a color-related adjustment.
Aspect 7 is the apparatus of aspect 2, where each of the set of ROIs is assigned a higher composition priority compared to other ROIs in the set of ROIs for each non-rotation animation layer in the plurality of layers.
Aspect 8 is the apparatus of any of aspects 1 to 7, where to detect whether each of the plurality of layers is a rotation animation layer or a non-rotation animation layer, the at least one processor is configured to: identify whether a set of coordinates and shapes for each of the plurality of layers includes an adjustment.
Aspect 9 is the apparatus of aspect 8, where each rotation animation layer in the plurality of layers includes the set of coordinates and shapes with the adjustment, and where each non-rotation animation layer in the plurality of layers includes the set of coordinates and shapes without the adjustment.
Aspect 10 is the apparatus of any of aspects 1 to 9, where the rotation animation layer is a layer that rotates during an animation at the DPU or the GPU, and where the non-rotation animation layer is a layer that does not rotate during the animation at the DPU or the GPU.
Aspect 11 is the apparatus of any of aspects 1 to 10, where the at least one processor is further configured to: mark, based on mapping each of the plurality of layers for the processing at the DPU or the GPU, each of the plurality of layers that are mapped for the processing at the DPU.
Aspect 12 is the apparatus of any of aspects 1 to 11, where the first per-layer processor at the DPU is assigned to each rotation animation layer in the plurality of layers if an available layer size at the DPU is greater than a layer size threshold.
Aspect 13 is the apparatus of aspect 12, where the layer size threshold is configurable or adjustable by a central processing unit (CPU).
Aspect 14 is the apparatus of any of aspects 1 to 13, where the plurality of layers is associated with a layer stack or a regional layer stack.
Aspect 15 is the apparatus of any of aspects 1 to 14, where the frame buffer corresponds to a composition output at the GPU.
Aspect 16 is the apparatus of any of aspects 1 to 15, where the at least one processor is further configured to: transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers.
Aspect 17 is the apparatus of any of aspects 1 to 16, where the apparatus is a wireless communication device, further including at least one of an antenna or a transceiver coupled to the at least one processor, where the at least one processor is configured to obtain the indication of the at least one frame via at least one of the antenna or the transceiver.
Aspect 18 is a method of display processing for implementing any of aspects 1 to 17.
Aspect 19 is an apparatus for display processing including means for implementing any of aspects 1 to 17.
Aspect 20 is a computer-readable medium (e.g., a non-transitory computer-readable medium) storing computer executable code, the code when executed by at least one processor causes the at least one processor to implement any of aspects 1 to 17.

What is claimed is:

1. An apparatus for display processing, comprising:
a memory; and
at least one processor coupled to the memory and, based at least in part on information stored in the memory, the at least one processor is configured to:
obtain an indication of at least one frame including a plurality of layers, wherein the at least one frame is associated with the display processing;
map each of the plurality of layers for processing at a display processing unit (DPU) or a graphics processing unit (GPU);
detect whether each of the plurality of layers is a rotation animation layer or a non-rotation animation layer based on the mapping for each of the plurality of layers;
divide a frame buffer into a set of regions of interest (ROIs) for each non-rotation animation layer in the plurality of layers; and
assign a first per-layer processor at the DPU to each rotation animation layer in the plurality of layers or at least one second per-layer processor at the DPU to each of the set of ROIs in the frame buffer for each non-rotation animation layer in the plurality of layers.

2. The apparatus of claim 1, wherein the first per-layer processor corresponds to a first composition stage for each rotation animation layer in the plurality of layers, and wherein the at least one second per-layer processor corresponds to a second composition stage for each of the set of ROIs in the frame buffer.

3. The apparatus of claim 2, wherein the at least one processor is further configured to:
process each non-rotation animation layer in the plurality of layers based on the second composition stage for each of the set of ROIs in the frame buffer.

4. The apparatus of claim 3, wherein to process each non-rotation animation layer in the plurality of layers based on the second composition stage, the at least one processor is configured to: blend each non-rotation animation layer in the plurality of layers based on the second composition stage.

5. The apparatus of claim 3, wherein each non-rotation animation layer in the plurality of layers is processed if at least one of: (i) the non-rotation animation layer is on top of a regional layer stack and the non-rotation animation layer has a constant blending alpha value, or (ii) the non-rotation animation layer is not on top of the regional layer stack and the non-rotation animation layer is covered by one or more transparent layers.

6. The apparatus of claim 3, wherein each non-rotation animation layer in the plurality of layers is associated with a color configuration adjustment or a color-related adjustment.

7. The apparatus of claim 2, wherein each of the set of ROIs is assigned a higher composition priority compared to other ROIs in the set of ROIs for each non-rotation animation layer in the plurality of layers.

8. The apparatus of claim 1, wherein to detect whether each of the plurality of layers is the rotation animation layer or the non-rotation animation layer, the at least one processor is configured to: identify whether a set of coordinates and shapes for each of the plurality of layers includes an adjustment.

9. The apparatus of claim 8, wherein each rotation animation layer in the plurality of layers includes the set of coordinates and shapes with the adjustment, and wherein each non-rotation animation layer in the plurality of layers includes the set of coordinates and shapes without the adjustment.

10. The apparatus of claim 1, wherein the rotation animation layer is a layer that rotates during an animation at the DPU or the GPU, and wherein the non-rotation animation layer is a layer that does not rotate during the animation at the DPU or the GPU.

11. The apparatus of claim 1, wherein the at least one processor is further configured to:
mark, based on mapping each of the plurality of layers for the processing at the DPU or the GPU, each of the plurality of layers that are mapped for the processing at the DPU.

12. The apparatus of claim 1, wherein the first per-layer processor at the DPU is assigned to each rotation animation layer in the plurality of layers if an available layer size at the DPU is greater than a layer size threshold.

13. The apparatus of claim 12, wherein the layer size threshold is configurable or adjustable by a central processing unit (CPU).

14. The apparatus of claim 1, wherein the plurality of layers is associated with a layer stack or a regional layer stack.

15. The apparatus of claim 1, further comprising at least one of an antenna or a transceiver coupled to the at least one processor, wherein the at least one processor is configured to obtain the indication of the at least one frame via at least one of the antenna or the transceiver, and wherein the frame buffer corresponds to a composition output at the GPU.

16. The apparatus of claim 1, wherein the at least one processor is further configured to:
transmit a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers.

17. A method of display processing, comprising:
obtaining an indication of at least one frame including a plurality of layers, wherein the at least one frame is associated with the display processing;
mapping each of the plurality of layers for processing at a display processing unit (DPU) or a graphics processing unit (GPU);
detecting whether each of the plurality of layers is a rotation animation layer or a non-rotation animation layer based on the mapping for each of the plurality of layers;
dividing a frame buffer into a set of regions of interest (ROIs) for each non-rotation animation layer in the plurality of layers; and
assigning a first per-layer processor at the DPU to each rotation animation layer in the plurality of layers or at least one second per-layer processor at the DPU to each of the set of ROIs in the frame buffer for each non-rotation animation layer in the plurality of layers.

18. The method of claim 17, wherein the first per-layer processor corresponds to a first composition stage for each rotation animation layer in the plurality of layers, and wherein the at least one second per-layer processor corresponds to a second composition stage for each of the set of ROIs in the frame buffer.

19. The method of claim 18, further comprising:
processing each non-rotation animation layer in the plurality of layers based on the second composition stage for each of the set of ROIs in the frame buffer.

20. The method of claim 19, wherein processing each non-rotation animation layer in the plurality of layers based on the second composition stage comprises: blending each non-rotation animation layer in the plurality of layers based on the second composition stage.

21. The method of claim 19, wherein each non-rotation animation layer in the plurality of layers is processed if at least one of: (i) the non-rotation animation layer is on top of a regional layer stack and the non-rotation animation layer has a constant blending alpha value, or (ii) the non-rotation animation layer is not on top of the regional layer stack and the non-rotation animation layer is covered by one or more transparent layers.

22. The method of claim 19, wherein each non-rotation animation layer in the plurality of layers is associated with a color configuration adjustment or a color-related adjustment.

23. The method of claim 18, wherein each of the set of ROIs is assigned a higher composition priority compared to other ROIs in the set of ROIs for each non-rotation animation layer in the plurality of layers.

24. The method of claim 17, wherein detecting whether each of the plurality of layers is the rotation animation layer or the non-rotation animation layer comprises: identifying whether a set of coordinates and shapes for each of the plurality of layers includes an adjustment, wherein each rotation animation layer in the plurality of layers includes the set of coordinates and shapes with the adjustment, and wherein each non-rotation animation layer in the plurality of layers includes the set of coordinates and shapes without the adjustment.

25. The method of claim 17, wherein the rotation animation layer is a layer that rotates during an animation at the DPU or the GPU, and wherein the non-rotation animation layer is a layer that does not rotate during the animation at the DPU or the GPU.

26. The method of claim 17, further comprising:
marking, based on mapping each of the plurality of layers for the processing at the DPU or the GPU, each of the plurality of layers that are mapped for the processing at the DPU.

27. The method of claim 17, wherein the first per-layer processor at the DPU is assigned to each rotation animation layer in the plurality of layers if an available layer size at the DPU is greater than a layer size threshold, wherein the layer size threshold is configurable or adjustable by a central processing unit (CPU).

28. The method of claim 17, further comprising:
transmitting a second indication of the assignment of the first per-layer processor at the DPU to each rotation animation layer in the plurality of layers or the at least one second per-layer processor at the DPU to each of the set of ROIs in the frame buffer for each non-rotation animation layer in the plurality of layers, wherein the plurality of layers is associated with a layer stack or a regional layer stack, and wherein the frame buffer corresponds to a composition output at the GPU.

29. An apparatus for display processing, comprising:
means for obtaining an indication of at least one frame including a plurality of layers, wherein the at least one frame is associated with the display processing;
means for mapping each of the plurality of layers for processing at a display processing unit (DPU) or a graphics processing unit (GPU);
means for detecting whether each of the plurality of layers is a rotation animation layer or a non-rotation animation layer based on the mapping for each of the plurality of layers;
means for dividing a frame buffer into a set of regions of interest (ROIs) for each non-rotation animation layer in the plurality of layers; and
means for assigning a first per-layer processor at the DPU to each rotation animation layer in the plurality of layers or at least one second per-layer processor at the DPU to each of the set of ROIs in the frame buffer for each non-rotation animation layer in the plurality of layers.

30. A computer-readable medium storing computer executable code for display processing, the code when executed by a processor causes the processor to:
obtain an indication of at least one frame including a plurality of layers, wherein the at least one frame is associated with the display processing;
map each of the plurality of layers for processing at a display processing unit (DPU) or a graphics processing unit (GPU);
detect whether each of the plurality of layers is a rotation animation layer or a non-rotation animation layer based on the mapping for each of the plurality of layers;
divide a frame buffer into a set of regions of interest (ROIs) for each non-rotation animation layer in the plurality of layers; and
assign a first per-layer processor at the DPU to each rotation animation layer in the plurality of layers or at least one second per-layer processor at the DPU to each of the set of ROIs in the frame buffer for each non-rotation animation layer in the plurality of layers.
